(19) United States
(12) Patent Application Publication
(10) Pub. No.: US 2014/0313257 A1
(43) Pub. Date: Oct. 23, 2014

(54) SYSTEM AND METHOD FOR SINGLE PASS PRINTING

(71) Applicant: Illinois Tool Works Inc., Glenview, IL (US)

(72) Inventor: Graham Vlcek, Arvada, CO (US)

(73) Assignee: Illinois Tool Works Inc., Glenview, IL (US)

(21) Appl. No.: 14/204,833

(22) Filed: Mar. 11, 2014

Related U.S. Application Data
(60) Provisional application No. 61/798,386, filed on Mar. 15, 2013.

(51) Int. Cl. B41J 25/304

(52) U.S. Cl. CPC B41J 25/304
USPC 347/20

(57) ABSTRACT

A printing system includes a printing assembly and a conveyance assembly. The printing assembly has one or more print heads configured to print one or more inks onto target objects. The conveyance assembly is configured to move the printing assembly relative to the one or more target objects. The conveyance assembly is configured to move the printing assembly so that the one or more print heads print the one or more inks onto the one or more target objects during a single pass of the printing assembly over the one or more target objects.

### CROSS-REFERENCE TO RELATED APPLICATIONS

This application claims priority to U.S. Provisional Application Ser. No. 61/798,386 (filed 15 Mar. 2013), the entire disclosure of which is incorporated by reference.

### BACKGROUND

Different types of printing systems have print heads that apply ink to objects to print on those objects. One type of known printing system is a scanning printer, wherein the print heads move relative to the objects during printing. These types of systems typically require the print heads to move over the objects several times during multiple passes so that a final resolution of an image that is printed on the objects is increased over the native resolution (e.g., the spacing of the print heads relative to each other). Printing with these systems, however, can be relatively time consuming.

Another type of printing system is a continuous printing system, where a continuum of the objects is continually moved beneath the print heads while the print heads print onto the objects. These types of systems typically require very tight manufacturing tolerances to ensure that all of the objects in the continuum of objects are closely aligned with the print heads. This can make the loading of additional objects for printing difficult and/or impossible.

### BRIEF SUMMARY

In one example of the inventive subject matter described herein, a printing system includes a printing assembly and a first conveyance assembly. The printing assembly includes one or more print heads configured to print one or more inks onto target objects. The first conveyance assembly is configured to move the printing assembly over the one or more of the target objects in a printing direction. The first conveyance assembly is configured to the printing assembly over the one or more of the target objects in the printing direction so that the one or more print heads complete printing of an image formed by the one or more inks onto the one or more target objects during a single pass of the printing assembly over the one or more target objects.

In another example of the inventive subject matter described herein, a printing method includes aligning one or more target objects along or parallel to a printing direction, moving the printing assembly over the one or more target objects along the printing direction, and printing one or more inks onto the one or more target objects during a single pass of the printing assembly along the printing direction over the one or more target objects.

In another example of the inventive subject matter described herein, another printing system includes plural print heads and a conveyance assembly. The plural print heads are aligned with each other along or parallel to a printing direction. The conveyance assembly is coupled with the plural print heads and is configured to move the plural print heads in the printing direction as the plural print heads print multiple different layers of ink on top of each other onto one or more target objects. The plural print heads complete printing of one or more images on the one or more target objects during a single pass of the plural print heads over the one or more target objects.

### BRIEF DESCRIPTION OF THE DRAWINGS

Reference is now made briefly to the accompanying drawings, in which:

FIG. 1 is a schematic diagram of an embodiment of a printing system;

FIG. 2 is a schematic view of an example of a printing assembly shown in FIG. 1 and substrates with target objects also shown in FIG. 1;

FIG. 3 is a side view of the printing assembly shown in FIG. 1 and one of the substrates shown in FIG. 1;

FIG. 4 is a flowchart of a method for single pass printing on target objects;

FIG. 5 is a schematic view of a printing assembly according to another example of the inventive subject matter described herein;

FIG. 6 is a side view of the printing assembly shown in FIG. 5; and

FIG. 7 is a cross-sectional view of an image printed onto one or more of the target objects during a single pass of the printing assembly over a set of the target objects according to one example of the inventive subject matter described herein.

### DETAILED DESCRIPTION

One or more embodiments of the inventive subject matter described herein relate to systems and methods for single pass printing on one or more various objects. Single pass printing refers to a printing system setup where a substrate (that is to be printed upon or that carries one or more target objects to be printed on) passes under one or more print heads a single time for printing one or more images onto the substrate and/or the target objects. In one embodiment, the print heads are moving while the substrate and the target objects remain stationary or substantially stationary. The images that are printed may include indicia, text, graphics, images, or the like. The print heads may be ink jet print heads that dispense ink via nozzles, or another type of ink dispenser, such as pads having ink disposed thereon, rollers having ink disposed thereon, or the like.

In one embodiment, the target objects are disposed on a substrate that remains stationary while the printing assembly that includes the print heads moves relative to the target objects in a printing direction. The printing assembly can include multiple print heads that apply different layers of printing material onto the target objects. For example, the printing assembly can include a background print head, one or more process print heads, and a coating print head. The background print head moves ahead of the other print heads along the printing direction as the printing assembly moves in the printing direction. The background print head applies a background layer of ink (e.g., white ink or ink of another color) onto the target object as the printing assembly moves in the printing direction. The background layer of ink can at least partially or completely cure before at least one process print head moves over the target object in the printing direction and applies at least one process layer of ink. The process layer of ink is applied on top of at least part of the background layer of ink. One or more additional process layers of ink can be subsequently applied by one or more additional process print heads moving over the target object along the printing direction. The process layers of ink can be applied on top of each other and/or on top of the background layer to form an image, text, or the like, on the target object. The coating print head then moves over the target object along the printing direction subsequent to the process print head(s) to apply a layer of a protective coating (e.g., clear coat or other coat) on the process layers of ink and/or the background layer of ink. The layer of the protective coating can protect the underlying process layers of ink and the background layer of ink.

The completed image can be printed onto the target object with a single pass of the printing assembly and the print heads over the target object. For example, the background print head may pass over the target object only one time to completely finish the printing of the background layer of ink on the target object, the process print heads may pass over the target object only one time to completely finish the printing of the process layers of ink on the target object, and the coating print head may pass over the target object only one time to completely finish the printing of the coating layer on the target object.

Each layer that is printed by the printing assembly may be fully or partially cured to eliminate excessive mixing between the layers. This curing can improve the quality of the final image that is printed on the target object by the printing assembly. For example, curing devices can apply energy (e.g., plasma, heat, moving air, or the like) to one or more printed layers of ink after the layers are printed and prior to printing a subsequent layer. The curing devices can be disposed between two or more of the print heads along the printing direction. After a print head that leads a curing device along the printing direction prints a layer onto the target object, the curing device can then cure the layer printed on the target object. Another print head may follow the curing device along the printing direction to print another layer onto the cured layer. Additional curing devices and/or print heads can subsequently print and cure more layers.

The printing assembly can include multiple sets of print heads and/or curing devices in order to concurrently or simultaneously print on multiple target objects in a single pass. For example, a first set of print heads and/or curing devices can be linearly arranged in a line that is coincident with the printing direction. At least a second set of print heads and/or curing devices can be linearly aligned with each other in a direction that is parallel to the printing direction. The second set of print heads and/or curing devices can be laterally offset from the first set of print heads and/or curing devices by a distance that permits the second set of print heads and/or curing devices to print onto one or more target objects while the first set of print heads and/or curing devices prints onto another one or more target objects, and while both the first and second sets of print heads and/or curing devices move in the printing direction.

In an embodiment, once a set of the target objects on the substrate have moved relative to the print heads and have been printed on, the substrate (and/or another substrate) may index (e.g., move laterally or transversely with respect to the direction in which the substrate and/or target objects move during printing) with respect to the print heads so that another set of the target objects and/or another substrate is positioned to move relative to the print heads for printing thereon. Because the sets of target objects and/or substrates are printed on in this manner, a manual or automated loader of additional sets of target objects and/or substrates can more easily load the additional sets of target objects and/or substrates into the system. For example, because the substrates and/or target objects are not continuously moving beneath the print heads, there may be larger tolerances for loading additional substrates and/or target objects into the system.

As one example, after the target object(s) are printed on (by the first and/or second sets of print heads and/or curing devices), the target object(s) may index (e.g., move a designated amount) in a lateral direction that is perpendicular to the printing direction. This lateral direction can be referred to as a lateral direction. In the lateral direction, new target objects can be placed upstream of the target objects that have been printed on to provide more target objects to be printed on in a single pass by the printing assembly.

Additional printing processes may be performed with additional zones of the print heads in order to increase the resolution of the images being printed. The width of the printing area can be increased by adding more print heads along directions oriented transverse (e.g., perpendicular) to the direction in which the substrate and/or target objects move below the print heads. For example, the print heads may print the inks onto the target object over a printing width dimension that is measured along the lateral direction. If a width dimension of the image to be printed onto the target object is larger than the printing width dimension, then multiple print heads may be disposed side-by-side along the lateral direction in order to increase the printing width dimension. For example, if each print head has a printing width dimension of 70 millimeters (or another distance), and the width dimension of the image is 200 millimeters, then three of the print heads for one or more of the layers to be printed on the target object may be laterally offset from each other along the lateral direction to increase the printing width dimension of the print assembly.

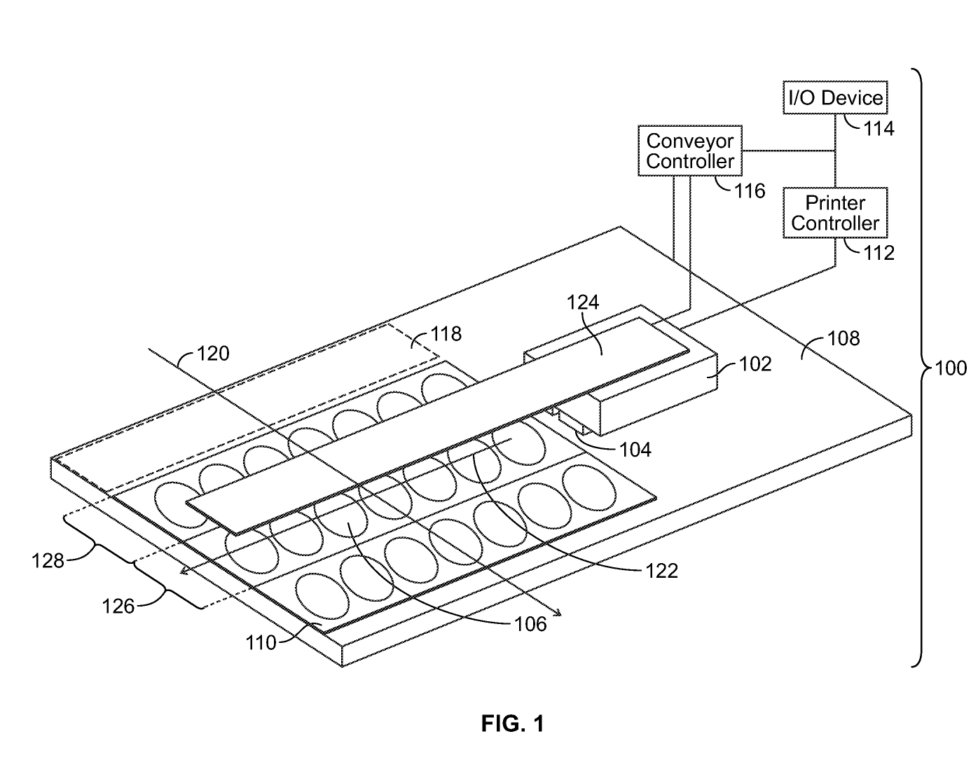

FIG. 1 is a schematic diagram of an embodiment of a printing system 100. The printing system 100 includes a printing assembly 102 having one or more print heads 104. The print heads 104 can represent ink jet print heads that each dispense ink to print on one or more target objects 106. Optionally, one or more, or all, of the print heads 104 may be a different type of device that prints ink onto the target objects 106. The printing assembly 102 can include one or more processors, controllers, and the like, that direct the print heads 104 to eject ink onto the target objects 106.

The printing system 100 includes conveyance assemblies 108, 124. The conveyance assembly 108 supports substrates 110 on which the target objects 106 are disposed. The conveyance assembly 124 is connected with the printing assembly 102 to move the printing assembly 102 over the target objects 106. The conveyance assemblies 108, 124 can include one or more belts, tracks, rails, or the like, that move the printing assembly 102, the substrates 110, and/or the target objects 106. Optionally, the substrates 110 and target objects 106 may not be moved by any conveyance assembly.

The printing assembly 102 is communicatively coupled (e.g., by one or more wired and/or wireless connections) to a printer controller 112. The printer controller 112 may represent one or more processors, controllers, hardware, software, and/or associated circuitry that controls operations of the conveyance assembly 124 and/or the printing assembly 102. The printer controller 112 is communicatively coupled with an input and/or output device 114 (“I/O Device” in FIG. 1), such as a computer, touchscreen, display device, stylus, keyboard, electronic mouse, microphone, acoustic speaker, or the like, that receives manual input from an operator of the system 100 to control operations of the printing system 100 and/or notifies the operator of performance of the printing system 100.

The conveyance assembly 108 and/or the conveyance assembly 124 are communicatively coupled to a conveyor controller 116. The conveyor controller 116 may represent one or more processors, controllers, hardware, software, and/or associated circuitry that controls operations of the conveyance assembly 108 and/or the conveyance assembly 124. For example, the conveyor controller 116 may control when the conveyance assembly 108 moves the substrates 110 and target objects 106, when the conveyance assembly 124 moves the printing assembly 102, which direction(s) the substrates 110 and target objects 106 are moved, which direction the printing assembly 102 is moved, how fast the substrates 110 and target objects 106 are moved, how fast the printing assembly 102 is moved, and the like. In one embodiment, the substrates and target objects remain stationary while the printing assembly 102 is moved. The conveyor controller 116 can be communicatively coupled with the input and/or output device 114 to receive manual input from an operator of the system 100.

One or more substrates 110 with a set of one or more target objects 106 (where a set can include a single target object 106 or multiple target objects 106) are loaded onto the conveyance assembly 108. In one aspect, the substrates 110 can be separately placed onto the conveyance assembly 108 in a loading area 118 of the conveyance assembly 108. For a substrate 110 having target objects 106 to be printed on next by the printing assembly 102, the conveyance assembly 108 moves that substrate 110 in an indexing direction 120 (which also may be referred to as a lateral or transverse direction) to a position where the target objects 106 are aligned with the print heads 104 of the printing assembly 102 along a printing direction 122.

The conveyance assembly 108 stops movement of the substrates 110 on the conveyance assembly 108 when the substrate 110 having the target objects 106 to next be printed on is aligned with the print heads 104 of the printing assembly 102. The substrate 110 may be aligned with the print heads 104 when the substrate 110 is positioned such that, when the printing assembly 102 is moved in the printing direction 122, the print heads 104 move relatively close to the target objects 106 on the substrate 110 so that the print heads 104 can print on these target objects 106 as the print heads 104 move. Optionally, the conveyance assembly 108 may be connected with the printing assembly 102 such that the conveyance assembly 108 moves the printing assembly 102 in the indexing direction 120. For example, instead of or in addition to moving the target objects 106 in the indexing direction 120, the printing assembly 102 may be moved in the indexing direction 120.

The conveyance assembly 124 moves the printing assembly 102 along the printing direction 122. As this printing assembly 102 moves in the printing direction 122, the print heads 104 to apply ink onto the target objects 106 on the substrate 110. In one embodiment, the conveyance assembly 122 moves the printing assembly 102 over the target objects 106 being printed on a single time to complete printing on the target objects 106. After the printing assembly 102 has passed over the target objects 106 being printed on a single time, the conveyance assembly 108 may index the substrate 110 in the indexing direction 120 in order to align the next substrate 110 with the print heads 104 along the printing direction 122. For example, the conveyance assembly 108 may incrementally move the substrates 110 on the conveyance assembly 108 in the indexing direction 120 so that the substrate 110 having the target objects 106 that were just printed on are no longer aligned with the print heads 104 along the printing direction 122, but the next substrate 110 (having target objects 106 that have not yet been printed upon by the printing assembly 102) is aligned with the print heads 104 along the printing direction 122.

For example, a first set 126 of target objects 106 may be linearly aligned with each other along the printing direction 122 beneath the printing assembly 102 so that the printing assembly 102 can move in the printing direction 122 a single time to complete the printing of one or more images on the target objects 106. In one embodiment, the printing of the images is completed in that no further application of inks are needed to finish the image. A different, second set 128 of target objects can be linearly aligned with each other in a direction that is parallel to the printing direction 122, but that is laterally offset from the first set 126 of the target objects 106 along the indexing direction 120. The printing assembly 102 moves over the first set 126 of target objects 106, but not the second set 128 of target objects 106, during printing on the first set 126 of target objects 106 in one embodiment. The printing assembly 102 does not print on the target objects 106 in the second set 128 while printing on the first set 126 of the target objects 106 in one embodiment. Alternatively, the printing assembly 102 may at least partially pass over both the first and second sets 126, 128 of target objects 106 in a single pass, while printing on at least part of the first and second sets 126, 128 of the target objects 106.

After the target objects 106 in the first set 126 are printed on, the conveyance assembly 108 can move the first and second sets 126, 128 of the target objects 106 in the indexing direction 120. The conveyance assembly 124 can move the printing assembly 102 back in a direction that is opposite to the printing direction 122. For example, the printing assembly 102 can be retreated back to a position where the printing assembly 102 was located prior to printing on the first set 126 of the target objects 106. The target objects 106 can be indexed such that the second set 128 of the target objects 106 are linearly aligned with each other along the printing direction 122 beneath of the printing assembly 102.

The conveyance assembly 124 may then move the printing assembly 102 again in the printing direction 122, but this time with the printing assembly 102 moving over the second set 128 of the target objects 106. As described above, the printing assembly 102 can complete the printing of images onto the target objects 106 in the second set 128 in a single pass or movement of the printing assembly 102 over the target objects 106 in the second set 128 along the printing direction 122.

The printing system 100 can repeat this process for additional sets of target objects 106, such as by repeatedly moving the substrates 110 and target objects 106 in the indexing direction 120, moving the printing assembly 102 over a set of the target objects 106 in the printing direction 122 a single time to complete printing on that set of the target objects 106, moving the substrates 110 having the target objects 106 that have been printed upon in the indexing direction 120 to align the next substrate 110 and target objects 106 with the printing assembly 102, and so on.

An operator may load additional substrates 110 with target objects 106 to be printed upon in the loading area 118 during printing of the target objects 106 on one or more other substrates 110. The loading area 118 is located upstream (along the indexing direction 120) of one or more other sets of the target objects 106 that are being printed on or that will be printed on before the newly loaded target objects 106. Because the newly loaded substrates 110 and target objects 106 need not be aligned with the printing assembly 102 when the newly loaded substrates 110 and target objects 106 are placed onto the conveyance assembly 108, there is greater tolerance for the positioning of the newly loaded substrates 110 and target objects 106 on the conveyance assembly 108. After loading of the new substrate 110 and target objects 106, the conveyance assembly 108 may move the new substrate 110 and the target objects 106 on the new substrate 110 into alignment with the printing assembly 102, as described above. The operator is not tasked with ensuring that the new substrates 110 are aligned with the printing assembly 102 or the print heads 104 along the printing direction 122 and, as a result, the operator may be able to more quickly load the new substrates 110 onto the conveyance assembly 108.

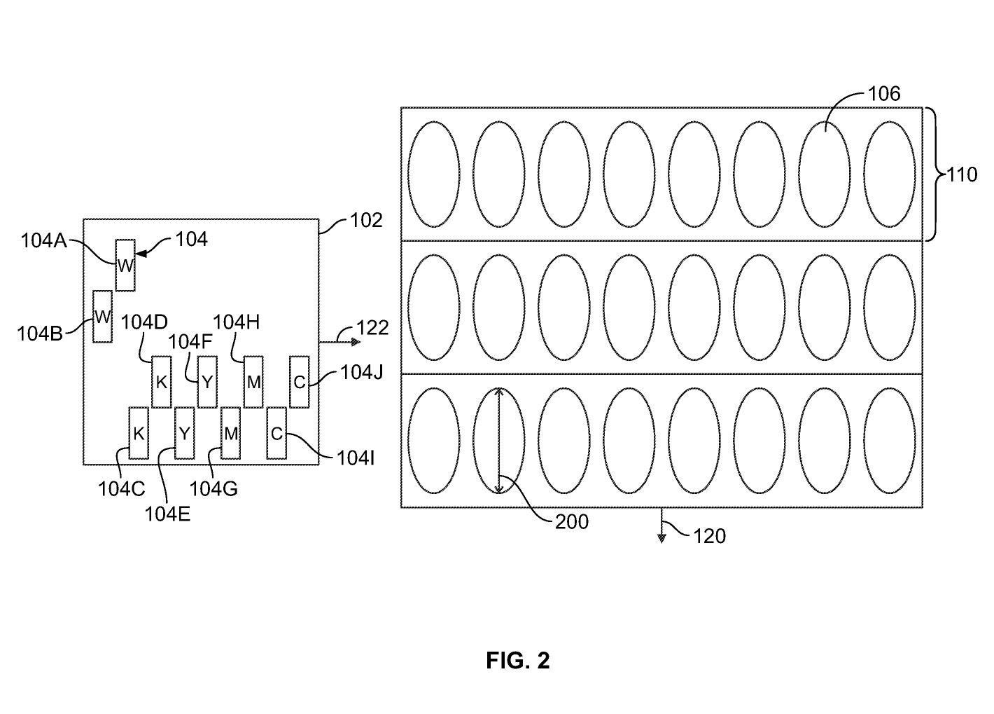

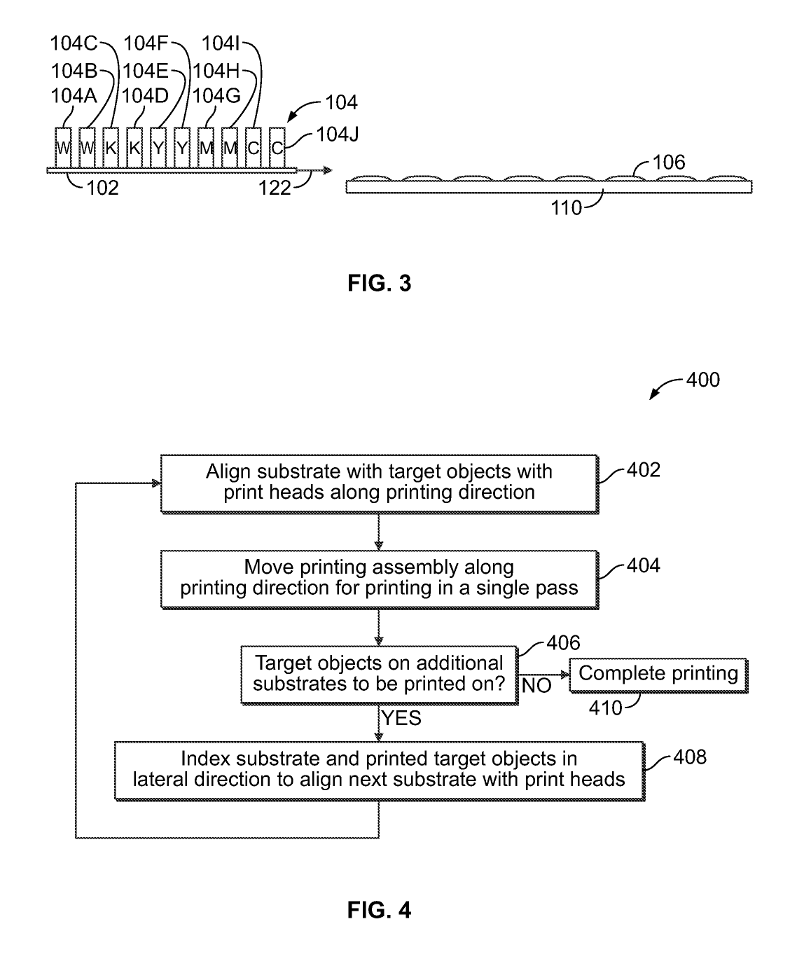

FIG. 2 is a schematic view of an example of the printing assembly 102 and the substrates 110 with the target objects 106. FIG. 3 is a side view of the printing assembly 102 and one of the substrates 110. The view of the printing assembly 102 shows the relative locations of several print heads 104 of the printing assembly 102 (e.g., print heads 104A-J). For example, even though the print heads 104 may not be visible from the top side of the printing assembly 102, FIG. 2 illustrates where the print heads 104 may be located on an opposite side of the printing assembly 102 (e.g., the side that faces the substrates 110).

In the illustrated example, the print heads 104 are offset from one another. For example, the print heads 104A, 104B are not aligned with the other print heads 104C-J in a direction that is parallel to or coincident with the printing direction 122. Additionally, the print heads 104A and 104B are not aligned with each other in a direction that is parallel to or coincident with the printing direction 122 and the print heads 104C, 104E, 104G, and 104I are not aligned with the print heads 104D, 104F, 104H, and 104J in a direction that is parallel to or coincident with the printing direction 122. The print heads 104C, 104E, 104G, and 104I are aligned with each other in a direction that is parallel to the printing direction 122 and the print heads 104D, 104F, 104H, and 104J are aligned with each other in a direction that is parallel to the printing direction 122. Alternatively, another arrangement of the print heads 104 and/or a different number of print heads 104 may be provided or used.

The print heads 104 may print the same (e.g., common) or different inks For example, the print heads 104A, 104B may both print white ink (e.g., as a background layer of ink for the image), the print heads 104I, 104J may both print cyan colored ink, the print heads 104G, 104H may both print magenta colored ink, and the print heads 104E, 104F may both print yellow colored ink. The print heads 104C, 104D may both print a coating layer, such as a clear coat.

The print heads 104 may be offset from each other in a direction that is parallel to or coincident with the indexing direction 120 to provide for increased printing width. As shown in FIG. 2, the individual print heads 104 are not sufficiently wide to print over an entire width dimension 200 of the target objects 106. The print heads 104C-J are laterally offset from each other so that the print heads 104C-J can print over the entire width dimension 200 of the target objects 106 during a single pass of the target objects 106 beneath the print heads 104C-J.

The print heads 104A, 104B may be positioned such that the print heads 104A, 104B do not print on the same target objects 106 as the print heads 104C-J during a single pass of the substrate 110 beneath the printing assembly 102. For example, during a single pass of the printing assembly 102 over the target objects 106, the print heads 104C-J may print onto the target objects 106 in the first set 126 while the print heads 104A-B print onto the target objects 106 in the second set 128. For example, the print heads 104A, 104B may be positioned to print on the target objects 106 of another substrate 110 while the print heads 104C-J print on the target objects 106 of a different substrate 110 during a single pass of the printing assembly 102 over the substrates 110. The print heads 104A, 104B may be offset in this manner to allow the print heads 104A, 104B to print one or more inks onto “dry” target objects 106 (e.g., target objects 106 that have not yet been printed on by the print heads 104C-J). The print heads 104A, 104B can print inks that are to underlie the inks printed by the other print heads 104C-J (e.g., white or clear inks).

Several print heads 104 that print the same color ink may be aligned with each other in a direction that is parallel to or coincident with the printing direction 122. Providing multiple print heads 104 in this manner can reduce or avoid chromatic banding, or inconsistent deposition of the ink on the target objects 106.

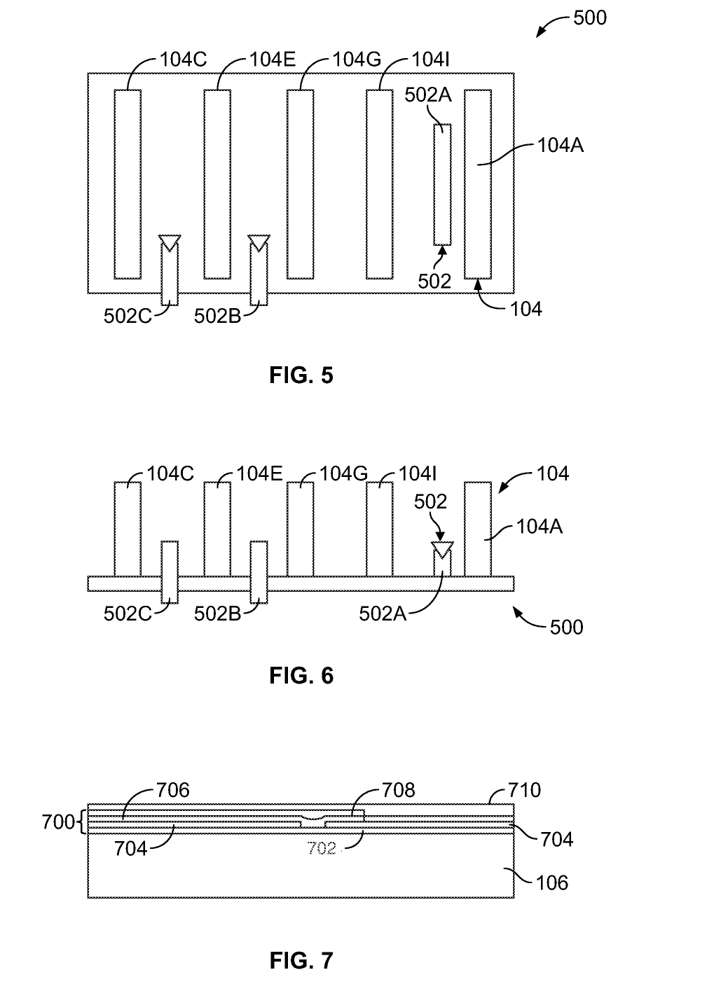

FIG. 5 is a schematic view of a printing assembly 500 according to another example of the inventive subject matter described herein. FIG. 6 is a side view of the printing assembly 500 shown in FIG. 5. The printing assembly 500 may be used in place of the printing assembly 102 shown in FIG. 1 in the printing system 100. One difference between the printing assemblies 102, 500 is that the printing assembly 500 includes fewer print heads 104, and the print heads 104 are not offset from each other. For example, the printing assembly 500 may include the print head 104A (but not the print head 104B), the print head 104C (but not the print head 104D), the print head 104E (but not the print head 104F), the print head 104G (but not the print head 104H), and the print head 104i (but not the print head 104J). Optionally, the printing assembly 500 may include a different number and/or arrangement of the print heads 104.

The printing assembly 500 also includes several curing devices 502 (e.g., curing devices 502A-C) disposed between the print heads 104 along the printing direction 122 (or along a direction that is parallel to the printing direction 122). The curing devices 502 may be in-line devices disposed between the print heads 104 along or parallel to the printing direction 122 (e.g., the curing device 502A) and/or offset devices (e.g., the curing devices 502B-C) that are between the print heads 104, but laterally offset from the print heads 104 in a direction that is parallel to or coincident with the indexing direction 120.

The curing devices 502 generate energy that assists in curing the inks deposited onto the target objects 106 by the print heads 104. For example, the curing devices 502 may generate plasma, heat, airflow, or the like, to speed up the curing of a recently deposited ink. The curing device 502A can generate energy to cure the ink applied by the print head 104A, the curing device 502B can generate energy to cure the ink applied by the print head 104G, the curing device 502C can generate energy to cure the ink applied by the print head 104E, and so on. The number and/or arrangement of the print heads 104 and/or curing devices 502 may vary from that shown in FIGS. 5 and 6. For example, fewer or more print heads 104 may be used, the print heads 104 may be laterally offset from each other, more or fewer curing devices 502 may be used, the curing devices 502 may be located between other print heads 104, or the like.

As described above, the printing assemblies 102, 500 may move over the target objects 106 so as to complete printing of images on the target objects 106 in a single pass along the printing direction 122. Because the print heads 104 are aligned with each other along or parallel to the printing direction 122, the print heads 104 may sequentially print the inks onto the target objects 106 during this single pass of the printing assembly 102 along the printing direction 122. As a result, the inks applied by the print heads 104 may be deposited on top of each other in layers, depending on the needs of the inks in forming the image.

FIG. 7 is a cross-sectional view of an image 700 printed onto one or more of the target objects 106 during a single pass of the printing assembly 102, 500 over a set of the target objects 106 according to one example of the inventive subject matter described herein. The image 700 is formed from several layers 702, 704, 706, 708 of ink, with a coating layer 710 disposed over the ink layers 702, 704, 706, 708 that form the image 700.

With respect to the printing assembly 102 shown in FIGS. 2 and 3, the ink layer 702 may be printed onto the target object 106 by the print head 104A, 104b (as shown in FIG. 2) during a single pass of the printing assembly 102 over the target object 106. The printing assembly 102 may then laterally move in the indexing direction 120 (shown in FIG. 1) so that the print heads 104c-j can move over the target object 106 when the printing assembly 102 again moves in the printing direction 122. During this movement, the print heads 104i, 104j can print the ink layer 704 onto the ink layer 702 on the target object 106. Because the print heads 104a,104b previously printed the ink layer 702 onto the target object 106, the ink layer 704 is printed onto the ink layer 702. After the print heads 104i, 104j print onto the target object 106, the print heads 104g, 104h can print the ink layer 706 onto the ink layer 704 and/or the ink layer 702 depending on the extent of surface area over which the ink layers 702, 704 are printed onto the target object 106. For example, because the ink layer 704 was not applied over all of the ink layer 702, the ink layer 706 may be directly deposited onto portions of the ink layer 702.

After the print heads 104g, 104h print onto the target object 106, the print heads 104e, 104f can print the ink layer 708 onto one or more of the ink layers 702, 704, 706, depending on the extent of surface area over which these ink layers are printed onto the target object 106. The coating layer 710, such as a clear coat or other protective coating layer, can then be printed onto the image 700 formed by one or more of the ink layers 702, 704, 706, 708, by the print heads 104c, 104d. Due to this sequential deposition of ink layers onto the target object 106, the layers 702, 704, 706, 708 of ink may be disposed on top of each other and/or between adjacent layers of ink.

With respect to the printing assembly 500 shown in FIG. 5, the ink layer 702 may be applied to the target object 106 by the print heads 104a, 104b, followed by deposition of the ink layer 704 by the print heads 104i, 104j, followed by printing of the ink layer 706 by the print heads 104g, 104h, followed by application of the ink layer 708 by the print heads 104e, 104f, followed by deposition of the coating layer 710 by the print heads 104c, 104d.

FIG. 4 is a flowchart of a method 400 for single pass printing on target objects. The method 400 may be used by the printing system 100 to print completed images on a single pass of the printing assembly 102, 500 over one or more target objects 106 in the printing system 100. At 402, the substrate 110 with the target objects 106 disposed thereon is aligned with print heads 104 of the printing system 100. For example, the next substrate 110 having the target objects 106 to be printed upon may be moved in the index or lateral direction 120 until the target objects 106 are aligned for being printed upon by the print heads 104.

At 404, the printing assembly 102 moves over the substrate 110 and the target objects 106 in the printing direction 122 while the target objects 106 remain stationary. The print heads 104 deposit ink onto the target objects 106 to complete the printing of one or more images on the target objects 106 with a single pass of the print heads 104 over the target objects 106.

At 406, a determination is made as to whether there are one or more additional substrates 110 with additional target objects 106 to be printed upon. If there are, the additional substrates 110 and target objects 106 may need to be moved to be aligned with the print heads 104 so that printing can be completed in a single pass of the print heads 104 over the target objects 106. As a result, flow of the method 400 can proceed toward 408. If there are no additional target objects 106 to be printed on, then flow of the method 400 can proceed toward 410, where printing is completed.

At 408, the substrate 110 and the target objects 106 are laterally moved, or indexed, in the indexing direction 120 so that another substrate 110 having another set of target objects 106 may be aligned with the print heads 104 for printing in a single pass. Flow of the method 400 may return to 402 for printing on this next set of target objects 106.

As described above, one or more embodiments of a system and method that provides for single pass printing onto target objects are provided. The configuration of the system 100 in one aspect involves utilizing a single pass print head configuration, where a native resolution matches the printed resolution of the image, and the image width can be scaled by adding additional print heads 104. This system 100 differs from a scanning printing system where the printed resolution per traverse of the print heads may be less than the final printed resolution. This system 100 differs from other printers having print heads that are stationary and a substrate that moves in multiple, different directions beneath the print heads (e.g., in a raster-like path) to print on the target objects on the substrate. The configurations of the system 100 disclosed herein allows the printing process to retain relatively fast printing speeds and high quality image appearances over the known printing systems.

The system 100 also allows for more process variations where print heads that apply different colors (e.g., white or clear) can be either in line with print heads that print other colors (e.g., aligned with one another along the printing direction 122) or offset from these other print heads (e.g., laterally separated from each other along a direction that is parallel to the indexing direction 120). Curing of the ink that is printed on the target objects 106 can vary per pass of the substrates 110, thereby allowing current process problems to be addressed without adding significant cost through additional print stations.

In one example of the inventive subject matter described herein, a printing system includes a printing assembly and a first conveyance assembly. The printing assembly includes one or more print heads configured to print one or more inks onto target objects. The first conveyance assembly is configured to move the printing assembly over the one or more of the target objects in a printing direction. The first conveyance assembly is configured to the printing assembly over the one or more of the target objects in the printing direction so that the one or more print heads complete printing of an image formed by the one or more inks onto the one or more target objects during a single pass of the printing assembly over the one or more target objects.

In one aspect, the one or more target objects include a first set of target objects and a second set of target objects. The printing system also can include a second conveyance assembly configured to move the first set of target objects and the second set of target objects in an indexing direction subsequent to the single pass of the printing assembly over the first set of target objects.

In one aspect, the indexing direction is oriented transverse to the printing direction.

In one aspect, the first conveyance assembly is configured to move the printing assembly in the printing direction over the second set of target objects in another single pass to print onto the second set of target objects.

In one aspect, the printing assembly includes first and second print heads that are laterally offset from each other in a direction that is transverse to the printing direction.

In one aspect, the one or more print heads are configured to print plural different layers of inks onto the target object, with the layers of inks printed on top of each other.

In one aspect, the one or more print heads include at least a first print head and a second print head laterally offset from each other in a direction that is transverse to the printing direction. The first print head and the second print head can be configured to concurrently print a common ink onto the one or more target objects when the printing assembly moves over the one or more target objects along the printing direction.

In one aspect, the printing assembly includes one or more curing devices configured to move in the printing direction over the one or more target objects and to cure the one or more inks during the single pass of the printing assembly over the one or more target objects.

In one aspect, the printing assembly includes at least two print heads, and the one or more curing devices are disposed between the at least two print heads along a direction that is parallel to or coincident with the printing direction.

In one aspect, the printing assembly includes at least two print heads, and the one or more curing devices are disposed between the at least two print heads but laterally offset from a direction that is parallel to or coincident with the printing direction.

In another example of the inventive subject matter described herein, a printing method includes aligning one or more target objects along or parallel to a printing direction, moving the printing assembly over the one or more target objects along the printing direction, and printing one or more inks onto the one or more target objects during a single pass of the printing assembly along the printing direction over the one or more target objects.

In one aspect, the one or more target objects include a first set of target objects and a second set of target objects, and moving the printing assembly can include moving the printing assembly along the printing direction over the first set of target objects to print the one or more inks onto the first set of target objects. The method also can include moving the first set of target objects and the second set of target objects in an indexing direction subsequent to the single pass of the printing assembly over the first set of target objects.

In one aspect, the indexing direction is oriented transverse to the printing direction.

In one aspect, the method also can include moving the printing assembly in the printing direction over the second set of target objects to print onto the second set of target objects in a single pass.

In one aspect, printing the one or more inks onto the one or more target objects during the single pass completes printing of one or more images on the one or more target objects.

In one aspect, printing the one or more inks includes concurrently printing a common ink from at least first and second print heads that are laterally offset from each other in a direction that is transverse to the printing direction.

In one aspect, printing the one or more inks includes printing plural different layers of inks onto the target object, with the layers of inks printed on top of each other.

In another example of the inventive subject matter described herein, another printing system includes plural print heads and a conveyance assembly. The plural print heads are aligned with each other along or parallel to a printing direction. The conveyance assembly is coupled with the plural print heads and is configured to move the plural print heads in the printing direction as the plural print heads print multiple different layers of ink on top of each other onto one or more target objects. The plural print heads complete printing of one or more images on the one or more target objects during a single pass of the plural print heads over the one or more target objects.

In one aspect, a width dimension of the one or more images that is measured in a direction that is transverse to the printing direction is longer than a width dimension in which each of the print heads can print onto the one or more target objects. The plural print heads can be laterally offset from each other along the direction that is transverse to the printing direction so that the plural print heads complete printing of the one or more images on the one or more target objects during the single pass.

In one aspect, the printing system also can include one or more curing devices configured to move with the plural print heads in the printing direction. The one or more curing devices can be configured to expose the one or more inks to an energy to cure the one or more inks during the single pass.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A printing system comprising:
a printing assembly having one or more print heads configured to print one or more inks onto target objects;
a first conveyance assembly configured to move the printing assembly over the one or more of the target objects in a printing direction,
wherein the first conveyance assembly is configured to the printing assembly over the one or more of the target objects in the printing direction so that the one or more print heads complete printing of an image formed by the one or more inks onto the one or more target objects during a single pass of the printing assembly over the one or more target objects.

2. The printing system of claim 1, wherein the one or more target objects include a first set of target objects and a second set of target objects, and further comprising a second conveyance assembly configured to move the first set of target objects and the second set of target objects in an indexing direction subsequent to the single pass of the printing assembly over the first set of target objects.

3. The printing system of claim 2, wherein the indexing direction is oriented transverse to the printing direction.

4. The printing system of claim 2, wherein the first conveyance assembly is configured to move the printing assembly in the printing direction over the second set of target objects in another single pass to print onto the second set of target objects.

5. The printing system of claim 1, wherein the printing assembly includes first and second print heads that are laterally offset from each other in a direction that is transverse to the printing direction.

6. The printing system of claim 1, wherein the one or more print heads are configured to print plural different layers of inks onto the target object, with the layers of inks printed on top of each other.

7. The printing system of claim 1, wherein the one or more print heads include at least a first print head and a second print head laterally offset from each other in a direction that is transverse to the printing direction, the first print head and the second print head configured to concurrently print a common ink onto the one or more target objects when the printing assembly moves over the one or more target objects along the printing direction.

8. The printing system of claim 1, wherein the printing assembly includes one or more curing devices, the one or more curing devices configured to move in the printing direction over the one or more target objects and to cure the one or more inks during the single pass of the printing assembly over the one or more target objects.

9. The printing system of claim 8, wherein the printing assembly includes at least two print heads, and the one or more curing devices are disposed between the at least two print heads along a direction that is parallel to or coincident with the printing direction.

10. The printing system of claim 8, wherein the printing assembly includes at least two print heads, and the one or more curing devices are disposed between the at least two print heads but laterally offset from a direction that is parallel to or coincident with the printing direction.

11. A printing method comprising:
aligning one or more target objects along or parallel to a printing direction;
moving the printing assembly over the one or more target objects along the printing direction; and
printing one or more inks onto the one or more target objects during a single pass of the printing assembly along the printing direction over the one or more target objects.

12. The printing method of claim 11, wherein the one or more target objects include a first set of target objects and a second set of target objects, and wherein moving the printing assembly includes moving the printing assembly along the printing direction over the first set of target objects to print the one or more inks onto the first set of target objects, and further comprising moving the first set of target objects and the second set of target objects in an indexing direction subsequent to the single pass of the printing assembly over the first set of target objects.

13. The printing method of claim 11, wherein the indexing direction is oriented transverse to the printing direction.

14. The printing method of claim 11, further comprising moving the printing assembly in the printing direction over the second set of target objects to print onto the second set of target objects in a single pass.

15. The printing method of claim 11, wherein printing the one or more inks onto the one or more target objects during the single pass completes printing of one or more images on the one or more target objects.

16. The printing method of claim 11, wherein printing the one or more inks includes concurrently printing a common ink from at least first and second print heads that are laterally offset from each other in a direction that is transverse to the printing direction.

17. The printing method of claim 11, wherein printing the one or more inks includes printing plural different layers of inks onto the target object, with the layers of inks printed on top of each other.

18. A printing system comprising:
plural print heads aligned with each other along or parallel to a printing direction; and
a conveyance assembly coupled with the plural print heads and configured to move the plural print heads in the printing direction as the plural print heads print multiple different layers of ink on top of each other onto one or more target objects, wherein the plural print heads complete printing of one or more images on the one or more target objects during a single pass of the plural print heads over the one or more target objects.

19. The printing system of claim 18, wherein a width dimension of the one or more images that is measured in a direction that is transverse to the printing direction is longer than a width dimension in which each of the print heads can print onto the one or more target objects, and wherein the plural print heads are laterally offset from each other along the direction that is transverse to the printing direction so that the plural print heads complete printing of the one or more images on the one or more target objects during the single pass.

20. The printing system of claim 18, further comprising one or more curing devices configured to move with the plural print heads in the printing direction, the one or more curing devices configured to expose the one or more inks to an energy to cure the one or more inks during the single pass.
